(19) United States
(12) Patent Application Publication
(10) Pub. No.: US 2018/0091950 A1
(43) Pub. Date: Mar. 29, 2018

(54) SYSTEMS AND METHODS FOR PREDICTING SERVICE TIME POINT

(71) Applicant: BEIJING DIDI INFINITY TECHNOLOGY AND DEVELOPMENT CO., LTD., Beijing (CN)

(72) Inventor: Lingyu ZHANG, Beijing (CN)

(73) Assignee: BEIJING DIDI INFINITY TECHNOLOGY AND DEVELOPMENT CO., LTD., Beijing (CN)

(21) Appl. No.: 15/566,220

(22) PCT Filed: Dec. 19, 2016
(86) PCT No.: PCT/CN2016/110785

§ 371 Date: Oct. 13, 2017

(30) Foreign Application Priority Data
Mar. 14, 2016 (CN) 201610142876.9

(51) Int. Cl. H04W 4/02; G06Q 10/04; H04L 29/08; G06F 17/30

(52) U.S. Cl. CPC H04W 4/028; G06Q 10/04; G01S 19/39; G06F 17/30; H04L 67/10

(57) ABSTRACT

The present disclosure relates to systems and methods for predicting a service time point. The system may perform the methods to obtain a set of historical service time points of a passenger to use a transportation service through at least one online transportation service providing platform; determine distribution information associated with the historical service time points; predict a service time point based on the distribution information; and push information associated with the transportation service to the passenger within a predetermined time period prior to the predicted service time point.

### CROSS-REFERENCE TO RELATED APPLICATIONS

This application claims priority to Chinese Application No. 201610142876.9 filed on Mar. 14, 2016, the content of which is incorporated herein by reference.

### TECHNICAL FIELD

The present disclosure generally relates to systems and methods for on-demand service, and in particular, systems and methods for predicting a distribution of future transportation service time point.

### BACKGROUND

With the development of Internet technology, on-demand transportation services, such as online taxi hailing services, have become more and more popular. There is a need for an online on-demand transportation service platform to send on-demand transportation service information to a service requestor prior to a service time point when a requestor uses the on-demand transportation service. In some situations, however, it may be difficult to predict the service time point efficiently.

### SUMMARY

According to an aspect of the present disclosure, a system may include one or more storage media and one or more processors configured to communicate with the one or more storage media. The one or more storage media may include a set of instructions for predicting a service time point of a passenger to use a transportation service. When the one or more processors execute the set of instructions, the one or more processors may be directed to perform one or more of the following operations. The one or more processors may obtain a set of historical service time points of a passenger to use a transportation service through at least one online transportation service providing platform. The one or more processors may determine distribution information associated with the historical service time points. The one or more processors may predict a service time point based on the distribution information. The one or more processors may push information associated with the transportation service to the passenger within a predetermined time period prior to the predicted service time point.

In some embodiments, the one or more processors may determine a plurality of first vectors based on the set of historical service time points, wherein each first vector may be associated with one historical service time point from the set of historical service time points. The one or more processors may determine a second vector based on the plurality of first vectors. The one or more processors may predict the service time point based on the second vector.

In some embodiments, the second vector may be determined based on a sum of the plurality of first vectors.

In some embodiments, each of the plurality of first vectors may be a unit vector that projects a corresponding historical service time point to a unit circular dial.

In some embodiments, each of the plurality of first vectors may be associated with a rectangular coordinate system. The rectangular coordinate system may include a positive horizontal coordinate referring to zero o'clock, a negative horizontal coordinate referring to twelve o'clock, a positive vertical coordinate referring to six o'clock, and a negative vertical coordinate, referring to eighteen o'clock.

In some embodiments, the plurality of first vectors may correspond to a plurality of first angles with respect to the positive horizontal coordinate.

In some embodiments, the one or more processors may determine a second angle of the second vector with respect to the positive horizontal coordinate. The one or more processors may predict the service time point based on the second angle.

In some embodiments, the predicted service time point may be a time such that the set of historical service time points may have a statistically minimum error distribution in view of the predicted service time point.

In some embodiments, the error distribution may include a set of time differences, wherein each time difference may be associated with a difference between the predicted service time point and a historical service time point of the set of historical service time points. The one or more processors may determine a discrete parameter associated with the set of time differences. The one or more processors may determine a time corresponding to a minimum value of the discrete parameter. The one or more processors may determine the time as the predicted service time point.

In some embodiments, the one or more processors may determine a first-order derivative of the discrete parameter. The one or more processors may determine the time corresponding to the minimum value of the discrete parameter based on the first-order derivative.

In some embodiments, the discrete parameter may include a quadratic sum of the set of time differences, a variance of the set of time differences, and/or a standard deviation of the set of time differences.

According to another aspect of the present disclosure, a method may include one or more of the following operations. A computer server may obtain a set of historical service time points of a passenger to use a transportation service through at least one online transportation service providing platform. The computer server may determine distribution information associated with the historical service time points. The computer server may predict a service time point based on the distribution information. The computer server may push information associated with the transportation service to the passenger within a predetermined time period prior to the predicted service time point.

In some embodiments, the computer server may determine a plurality of first vectors based on the set of historical service time points, wherein each first vector may be associated with one historical service time point from the set of historical service time points. The computer server may determine a second vector based on the plurality of first vectors. The computer server may predict the service time point based on the second vector.

In some embodiments, the second vector may be determined based on a sum of the plurality of first vectors.

In some embodiments, each of the plurality of first vectors may be a unit vector that projects a corresponding historical service time point to a unit circular dial.

In some embodiments, each of the plurality of first vectors may be associated with a rectangular coordinate system. The rectangular coordinate system may include a positive horizontal coordinate referring to zero o'clock, a negative horizontal coordinate referring to twelve o'clock, a positive vertical coordinate referring to six o'clock, and a negative vertical coordinate referring to eighteen o'clock.

In some embodiments, the plurality of first vectors may correspond to a plurality of first angles with respect to the positive horizontal coordinate.

In some embodiments, the computer server may determine a second angle of the second vector with respect to the positive horizontal coordinate. The computer server may predict the service time point based on the second angle.

In some embodiments, the predicted service time point may be a time such that the set of historical service time points may have a statistically minimum error distribution in view of the predicted service time point.

In some embodiments, the error distribution may include a set of time differences, wherein each time difference may be associated with a difference between the predicted service time point and a historical service time point of the set of historical service time points. The computer server may determine a discrete parameter associated with the set of time differences. The computer server may determine a time corresponding to a minimum value of the discrete parameter. The computer server may determine the time as the predicted service time point.

In some embodiments, the computer server may determine a first-order derivative of the discrete parameter. The computer server may determine the time corresponding to the minimum value of the discrete parameter based on the first-order derivative.

In some embodiments, the discrete parameter may include a quadratic sum of the set of time differences, a variance of the set of time differences, and/or a standard deviation of the set of time differences.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a block diagram illustrating an exemplary computing device in the on-demand service system according to some embodiments of the present disclosure;

FIG. 3-A is a block diagram illustrating an exemplary processing engine according to some embodiments of the present disclosure;

FIG. 3-B is a flowchart illustrating an exemplary process/method for predicting a service time point according to some embodiments of the present disclosure;

FIG. 4 is a flowchart illustrating an exemplary process/method for predicting a service time point according to some embodiments of the present disclosure;

FIG. 5 is a schematic diagram illustrating an exemplary rectangular coordinate system associated with a plurality of vectors according to some embodiments of the present disclosure; and

FIG. 6 is a flowchart illustrating an exemplary process/method for predicting a service time point according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to determining a target vehicle/provider, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “service request” and “order” in the present disclosure are used interchangeably to refer to request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable, or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure provides online systems and methods for predicting a service time point that a passenger will use a transportation service (e.g., online taxi hailing) based on the user's historical online activity related to the transportation service.

It should be noted that online on-demand transportation services, such as online taxi hailing, is a new form of service rooted only in post-Internet era. It provides technical solutions to users and service providers that could raise only in post-Internet era. In pre-Internet era, when a user calls for a taxi on street, the taxi request and acceptance occur only between the passenger and one taxi driver that sees the passenger. If the passenger calls a taxi through telephone call, the service request and acceptance may occur only between the passenger and one service provider (e.g., one taxi company or agent). Online taxi hailing, however, allows a user of the service to real-time and automatic distribute a service request to a vast number of individual service providers (e.g., taxi) distance away from the user. It also allows a plurality of service provides to respond to the service request simultaneously and in real-time. Meanwhile, in modern societies, taxi service has become an industry of huge scale. Millions of passengers take taxis every day via online taxi hailing platforms. Only through the help of Internet can studying behaviors of the passengers' taxiing behavior becomes possible. Accordingly, prediction of taxi hailing through a passenger's online taxi hailing activity, is also a new form of service rooted only in post Internet era.

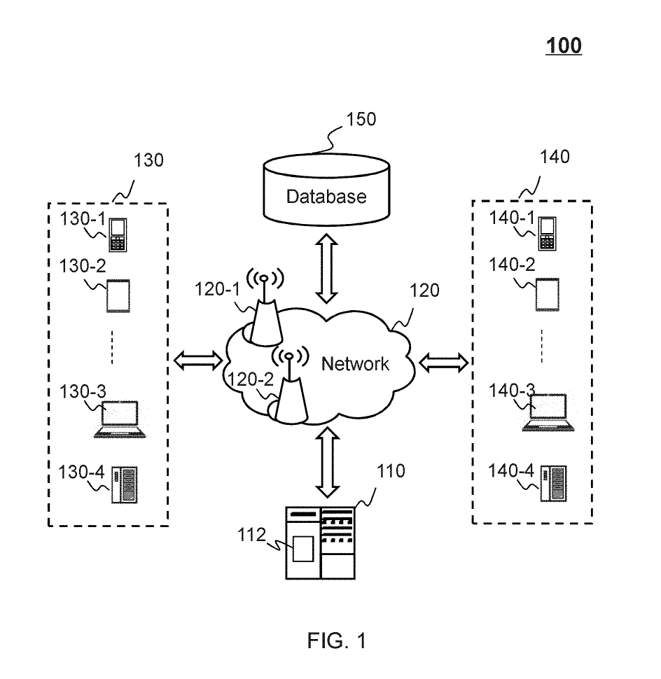

FIG. 1 is a block diagram of an exemplary on-demand service system 100 according to some embodiments. The on-demand service system 100 may be an online platform including a server 110, a network 120, a requestor terminal 130, a provider terminal 140, and a database 150. The server 110 may include a processing engine 112.

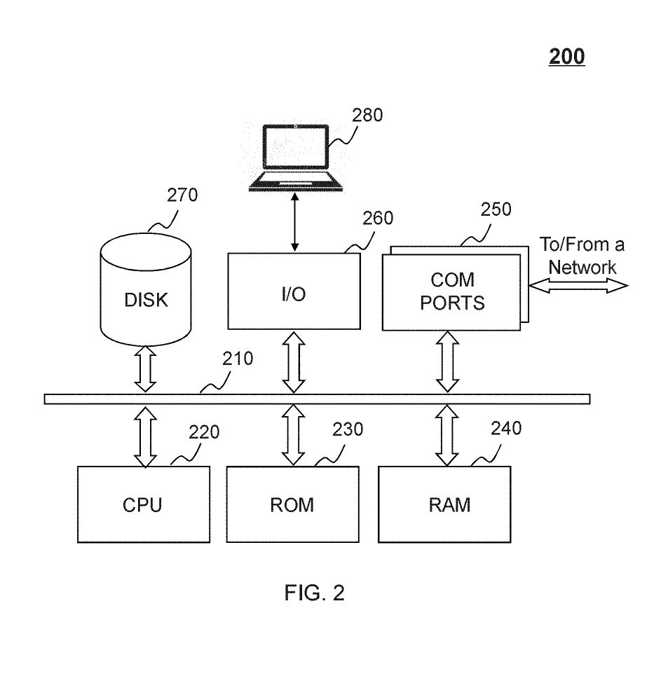

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may predict a service time point based on a set of historical service time points of a passenger to use a transportation service. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the requestor terminal 130, the provider terminal 140, and the database 150) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with other positioning device to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140, etc.). In some embodiments, the database 150 may be part of the server 110.

In some embodiments, one or more components in the on-demand service system 100 (e.g., the server 110, the requestor terminal 130, the provider terminal 140, etc.) may have a permission to access the database 150. In some embodiments, one or more components in the on-demand service system 100 may read and/or modify information relating to the requestor, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the CPU 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one CPU and/or processor is described in the computing device 200. However, it should be note that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

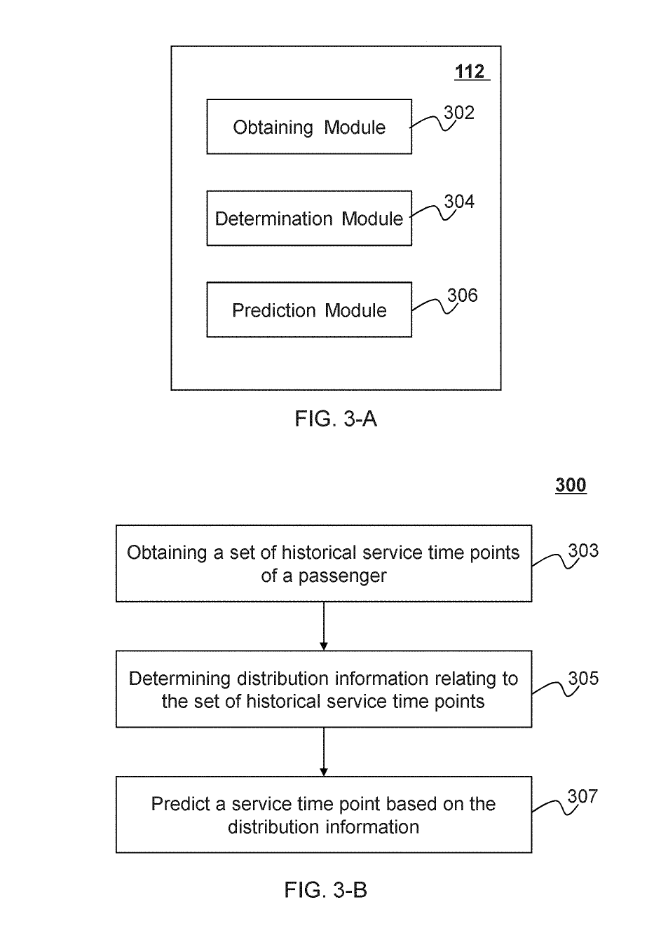

FIG. 3-A is a block diagram illustrating an exemplary processing engine 112 according to some embodiments of the present disclosure. The processing engine 112 may include an obtaining module 302, a determination module 304, and a prediction module 306.

The obtaining module 302 may be configured to obtain a set of historical service time points of a passenger to use a transportation service. As used herein, the service time point may refer to a start time when a passenger wishes to use a transportation service.

The determination module 304 may be configured to determine distribution information associated with the set of historical service time points. For example, for each of the set of historical service time points, the determination module 304 may determine a vector in a rectangular coordinate system.

The prediction module 306 may be configured to predict a service time point based on the distribution information. For example, the prediction module 306 may predict the service time point based on a plurality of vectors corresponding to the set of historical service time points. In some embodiments, the prediction module 306 may predict the service time point according to a golang frame via an application program interface (API).

In some embodiments, the processing engine 112 may further include a pushing module (not shown in FIG. 3-A). The pushing module may be configured to push information associated with the transportation service to the passenger. For example, the pushing module may push information relating to available providers (e.g., discount information, traffic condition) to the passenger within a predetermined time period prior to the predicted service time point. The predetermined time period may be 10 minutes, 15 minutes, 30 minutes, 45 minutes, or the like.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the obtaining module 302 and the determination module 304 may be integrated as a single module which may both obtain the set of historical service time points and determine the distribution information of the set of historical service time points.

FIG. 3-B is a flowchart illustrating an exemplary process/method 300 for predicting a service time point according to some embodiments of the present disclosure. The process and/or method 300 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 300.

In step 303, the processing engine 112 may obtain a set of historical service time points of a passenger to use a transportation service.

For example, the transportation service may be a taxi service. The set of historical service time points may be expressed in a 24-hour time system. The service time point may refer to a start time when a passenger wishes to use a transportation service. The processing engine 112 may obtain the passenger's historical service time points by recording his/her taxi hailing activity via the online on-demand service system 100. The processing engine 112 may obtain the passenger's historical service time points in real time or at a certain time interval (e.g., 10 minutes). The passenger may send a transportation service request to the on-demand service system 100 to use the transportation service. The transportation service request may include a real-time request and/or an appointment request. As used herein, a real-time request may be a request that the requestor wishes to use a transportation service at the present moment or at a defined time reasonably close to the present moment for an ordinary person in the art. For example, a request may be a real-time request if the defined time is shorter than a threshold value, such as 1 minute, 5 minutes, 10 minutes or 20 minutes. The appointment request may refer to that the requestor wishes to use a transportation service at a defined time which is reasonably far from the present moment for the ordinary person in the art. For example, a request may be an appointment request if the defined time is longer than a threshold value, such as 20 minutes, 2 hours, or 1 day. In some embodiments, the processing engine 112 may define the real-time request or the appointment request based on a time threshold. The time threshold may be default settings of the system 100, or may be adjustable depending on different situations. For example, in a peak demand period when there are higher service demand occurs, the time threshold may be relatively small (e.g., 10 minutes), otherwise in idle period (e.g., 10:00-12:00 am) when the service demand is low, the time threshold may be relatively large (e.g., 1 hour).

In step 305, the processing engine 112 may determine distribution information relating to the set of historical service time points.

For example, for each of the set of historical service time points, the processing engine 112 may determine a vector in a coordinate system. The coordinate system may include a rectangular coordinate system, a polar coordinate system, a spherical coordinate system, a cylindrical coordinate system, or the like, or a combination thereof. As another example, the processing engine 112 may determine statistical information of the set of historical service time points. As used herein, the statistical information may indicate a discrete distribution of the historical service time points that the passenger uses the online on-demand service, such as conducting an online taxi hailing service and/or getting on a taxi that the passenger hailed online.

In step 307, the processing engine 112 may predict a service time point based on the distribution information. For example, the processing engine 112 may predict the service time point based on a sum of a plurality of vectors corresponding to the set of historical service time points. As another example, the processing engine 112 may predict the service time point based on the statistical information of the set of historical service time points. The processing engine 112 may predict the service time point or update the predicted service time point in real time or at a certain time interval (e.g., 10 minutes).

After the processing engine 112 predicts the service time point, the processing engine 112 may push information associated with the transportation service to the passenger (e.g., discount information, traffic condition) within a predetermined time period prior to the predicted service time point. The predetermined time period may be default settings of the system 100, or may be adjustable depending on different situations. For example, the predetermined time period may be 10 minutes, 15 minutes, 30 minutes, 45 minutes, or the like.

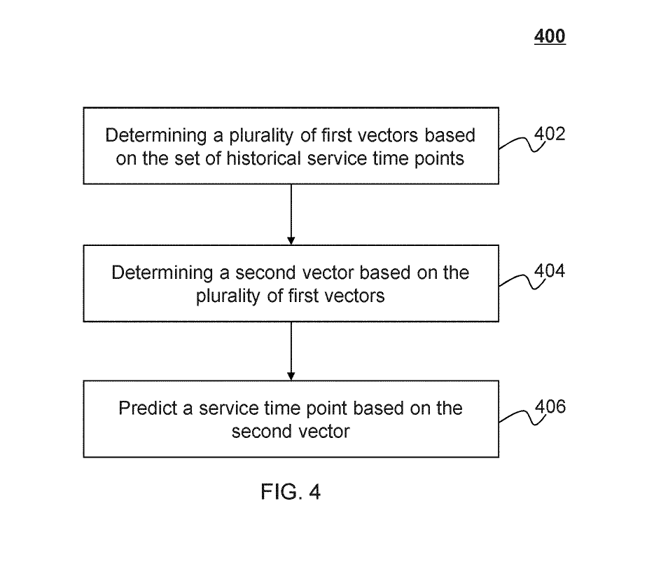

FIG. 4 is a flowchart illustrating an exemplary process/method 400 for predicting a service time point according to some embodiments of the present disclosure. The process and/or method 400 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 400.

In step 402, the processing engine 112 may determine a plurality of first vectors based on the set of historical service time points. Each of the plurality of first vectors corresponds to a historical service time point in the set of historical service time points. In some embodiments, each of the plurality of first vectors may be a multi-dimensional vector (e.g., a two-dimensional vector, a three-dimensional vector).

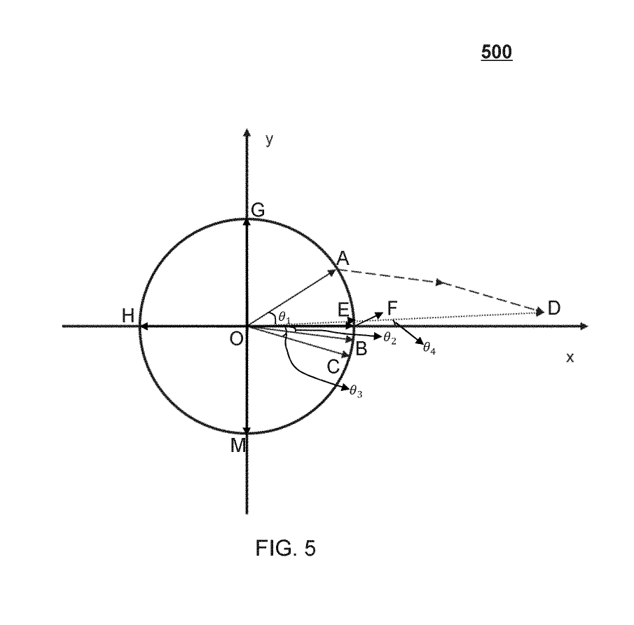

The plurality of first vectors may be expressed in a coordinate system. The coordinate system may include a rectangular coordinate system, a polar coordinate system, a spherical coordinate system, a cylindrical coordinate system, or the like, or a combination thereof. For example, each of the plurality of first vector may project a historical service time point into a circular dial. To this end, the rectangular coordinate system may include a positive horizontal coordinate, a negative horizontal coordinate, a positive vertical coordinate, and a negative vertical coordinate. In the rectangular coordinate system, each of the plurality of first vectors may be a unit vector, and for each of the plurality of first vectors, the processing engine 112 may determine a first angle (e.g., θ₁ illustrated in FIG. 5) with respect to the positive horizontal coordinate. For example, the processing engine 112 may determine an ith first vector as (cos θᵢ, sin θᵢ), where θᵢ is the ith first angle of the ith first vector with respect to the positive horizontal coordinate. The processing engine 112 may determine the first angle according to formula (1) below:

$${θ}_{i} = 2 π \cdot \frac{{x}_{i}}{24} . \qquad ( 1 )$$

where θᵢ refers to the ith first angle, and Xᵢ refers to an ith historical service time point. For example, if the historical service time point is 8:30, the value of Xᵢ is 8.5, and if the historical service time point is 8:15, the value of Xᵢ is 8.25. As another example, if the historical service time point is 3:00, the first angle is

$$\frac{π}{4} ;$$

if the historical service time point is 22:00, the first angle is

$$\frac{11 π}{6} ;$$

and if the historical service time point is 23:00, the first angle is

$$\frac{23 π}{12} .$$

As such, any time point between 0 o'clock and 24 o'clock may be expressed as a vector on a 0-24 o'clock dial. In other words, the first vector system in the above example may project each time point of a day into a unit vector on a unit circle, where the time point is expressed as the unit vector's angle in the unit circle.

In step 404, the processing engine 112 may determine a second vector based on the plurality of first vectors.

The processing engine 112 may further determine a second angle of the second vector with respect to the positive horizontal coordinate. In some embodiments, the second vector may be a sum of the plurality of first vectors. For example, the processing engine 112 may determine the second vector according to formula (2) below:

(cos θₜ,sin θₜ)=(Σᵢ₌₁ⁿ cos θᵢ,Σᵢ₌₁ⁿ sin θᵢ) (2)

where (cos θₜ, sin θₜ) refers to the second vector, θₜ refers to the second angle, and n refers to the number of the set of historical service time points.

In some embodiments, the processing engine 112 may normalize the second vector. For example, the processing engine 112 may modify the second vector as a second unit vector (e.g., \vec{OE} illustrated in FIG. 5).

In step 406, the processing engine 112 may predict a service time point based on the second vector. In order to predict the service time point, the processing engine 112 may determine the second angle according to formula (3) below:

$${θ}_{t} = {cos}^{- 1} \frac{{\sum }_{i = 1}^{n} cos {θ}_{i}}{\sqrt{{( {\sum }_{i = 1}^{n} cos {θ}_{i} )}^{2} + {\sum }_{i = 1}^{n} sin {θ}_{i}^{2}}} \qquad ( 3 )$$

where θₜ refers to the second angle.

After the processing engine 112 determines the second angle, the processing engine 112 may predict the service time point based on the second angle according to formula (4) below:

$${X}_{t} = 24 \cdot \frac{{θ}_{t}}{2 π} \qquad ( 4 )$$

where Xₜ refers to the predicted service time point.

It should be noted that the above description is merely provided for the purposes of illustration, and not intended to limit the scope of the present disclosure. For persons having ordinary skills in the art, multiple variations and modifications may be made under the teachings of the present disclosure. For example, the second vector may be an average or a weighted-average of the plurality of first vectors. However, those variations and modifications do not depart from the scope of the present disclosure.

FIG. 5 is a schematic diagram illustrating exemplary first vectors and an exemplary second vector in a rectangular coordinate system according to some embodiments of the present disclosure.

As illustrated, the rectangular coordinate system may include a positive horizontal coordinate, a negative horizontal coordinate, a positive vertical coordinate, and a negative vertical coordinate. Point O refers to the origin of the rectangular coordinate system. The processing engine 112 may determine a unit circle from the origin O. As illustrated, the intersection of the unit circle and the positive horizontal coordinate is point F, and the vector \vec{OF} refers to zero o'clock (also referred to as “0:00”). The intersection of the unit circle and the negative horizontal coordinate is point H, and the vector \vec{OH} refers to twelve o'clock (also referred to as “12:00”). The intersection of the unit circle and the positive vertical coordinate is point G, and the vector \vec{OG} refers to six o'clock (also referred to as “6:00”). The intersection of the unit circle and the negative vertical coordinate is point M, and the vector \vec{OM} refers to eighteen o'clock (also referred to as “18:00”).

The processing engine 112 may obtain a first historical service time point, a second historical service time point, and a third historical service time point. The processing engine may further determine a vector \vec{OA} corresponding to the first historical service time point, a vector \vec{OB} corresponding to the second historical service time point, and a vector \vec{OC} corresponding to the third historical service time point in a rectangular coordinate system.

For the vector \vec{OA}, the processing engine 112 may determine a third angle θ₁ with respect to the positive horizontal coordinate. Similarly for the vector \vec{OB}, the processing engine 112 may determine a fourth angle θ₂ with respect to the positive horizontal coordinate. For the vector \vec{OC}, the processing engine 112 may determine a fifth angle θ₃ with respect to the positive horizontal coordinate.

Further, the processing engine 112 may determine a vector \vec{OD} based on a sum of the vector \vec{OA}, the vector \vec{OB}, and the vector \vec{OC}. And for the vector \vec{OD}, the processing engine 112 may determine a sixth angle θ₄ with respect to the positive horizontal coordinate. The processing engine 112 may predict a service time point based on the sixth angle θ₄ according to formula (3) and formula (4).

In some embodiments, the processing engine 112 may further normalize the vector \vec{OD}. For example, the processing engine 112 may determine an intersection point E of the vector \vec{OD} and the unit circle, and determine a vector \vec{OE} as the normalized vector.

It should be noted that the description in FIG. 5 is provided for illustration purposes, and not intended to limit the scope of the present disclosure. The coordinate system associated with the plurality of first vectors and the second vector may not be limited to a rectangular coordinate system.

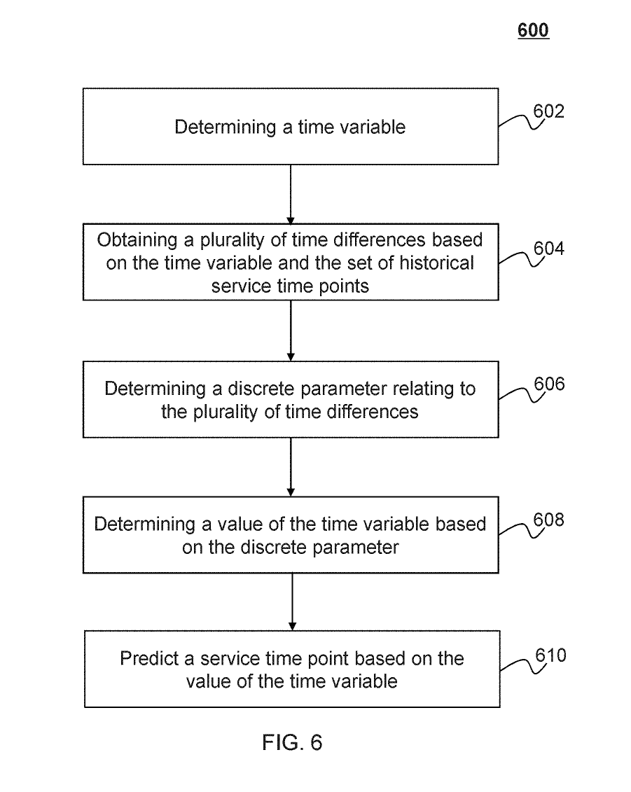

FIG. 6 is a flowchart illustrating an exemplary process/method 600 for predicting a service time point according to some embodiments of the present disclosure. The process and/or method 600 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 600.

In step 602, the processing engine 112 may determine a time variable.

As used herein, the time variable may refer to a variable to be determined based on which the processing engine 112 may predict a service time point.

In step 604, the processing engine 112 may obtain a set of time differences (also referred to as “error distribution”) based on the time variable and the set of historical service time points according to formula (5) below. Each of the plurality of time differences may correspond to a historical service time point in the set of historical service time points.

difference(Xₛ,Xᵢ)=−∥Xₛ—Xᵢ|−12|+12 (5)

where Xₛ refers to the time variable, Xᵢ refers to an ith historical service time point in the set of historical service time points, and difference(Xₛ,Xᵢ) refers to the time difference between the time variable and the ith historical service time point.

It may be seen that when |Xₛ−Xᵢ≦12, the time difference may be expressed as below:

difference(Xₛ,Xᵢ)=|Xₛ−Xᵢ| (6)

when |Xₛ−Xᵢ|>12, the time difference may be expressed as below:

difference(Xₛ,Xᵢ)=24−|X₁−X₂| (7)

In step 606, the processing engine 112 may determine a discrete parameter relating to the plurality of time differences. As used herein, the discrete parameter may indicate a dispersion degree of the time variable and the set of historical service time points. The discrete parameter may include a variance, a standard deviation, a quadratic sum, or the like, or a combination thereof. For example, the processing engine 112 may determine a quadratic sum of the plurality of time differences according to formula (8) below:

L(Xₛ)=Σᵢ₌₁ⁿ(−∥Xₛ−Xᵢ|−12|+12)² (8)

where L(Xₛ) refers to the quadratic sum of the plurality of time differences.

In step 608, the processing engine 112 may determine a value of the time variable based on the discrete parameter. The processing engine 112 may determine a value of the time variable which corresponds to a minimum value of the discrete parameter. For example, the processing engine 112 may determine a first-order derivative of the discrete parameter according to formula (9) below:

$${L ( {X}_{s} )}^{′} = {\sum }_{i = 1}^{n} 2 ( - \vert \vert {X}_{s} - {X}_{i} \vert - 12 \vert + 12 ) \times \frac{\vert {X}_{s} - {X}_{i} \vert - 12}{\vert \vert {X}_{s} - {X}_{i} \vert - 12 \vert} \times \frac{{X}_{s} - {X}_{i}}{\vert {X}_{s} - {X}_{i} \vert} \qquad ( 9 )$$

where L(Xₛ)′ refers to the first-order derivative of the quadratic sum of the plurality of time differences.

According to formula (9), the predicted service time point may be a time such that the set of historical service time points has a statistically minimum error distribution in view of the predicted service time point. That is, the predicted service time point may be a value of the time variable which makes the first-order derivative of the quadratic sum of the plurality of time differences equal to 0.

In order to determine the value of the time variable which makes the first-order derivative of the discrete parameter equal to 0, the processing engine 112 may determine a first value of the time variable according to formula (10) and formula (11) below:

|Xₛ−Xᵢ=0 (10)

∥Xₛ−Xᵢ|−12|=0 (11)

According to formula (10) and formula (11) above, the processing engine 112 may determine the first value of the time variable as below:

Xₛ=Xᵢ (12)

Xₛ=Xᵢ±12 (13)

The processing engine 112 may further determine a first set including a plurality first values of the time variable illustrated below:

S={Xᵢ−12,Xᵢ,Xᵢ+12|i=1,2,3, . . . ,n} (14)

where S refers to the first set.

It may be seen that in the first set there may be a first element which is less than or equal to 0 and a second element which is larger than 24. The processing engine 112 may remove the first element and the second element from the first set and determine a second set illustrated below:

A=(a₁,a₂,a₃, . . . ,a₂ₙ) (15)

it should be noted the elements in the second set are sequential, that is, the value of aᵢ₊₁ is larger than the value of aᵢ. It may be seen that the number of elements in the second set is 2n.

The processing engine 112 may further add an element “0” and an element “24” into the second set and determine a third set illustrated below:

B=(0,a₁,a₂a₃, . . . a₂ₙ,24) (16)

It may be supposed that the elements in the third set are arranged on a number axis, and the number axis may be divided into a plurality of sections by the elements. It is obvious that the number of the elements in the third set is 2n+2, and the number of the plurality of sections is 2n+1.

For each of the plurality of sections, the processing engine 112 may determine one or more second values of the time variable within the section, which make the first-order derivative of the quadratic sum of the plurality of time differences equal to 0 (i.e., the one or more second values of the time variable within the section correspond to the minimum value of the quadratic sum). During the process of determining the one or more second values of the time variable, the processing engine 112 may first select a specific section, and suppose that the value of the time variable is within the specific section, then the processing engine 112 may analyze formula (9) and determine a third value of the time variable which makes the first-order derivative of the quadratic sum of the plurality of time differences equal to 0. The processing engine 112 may determine whether the third value is within the specific section, if so, the processing engine 112 may store the third value; if not, the processing engine 112 may select another section and repeat the above process until all the plurality of sections are selected. The processing engine 112 may determine the stored third value(s) as the second value(s) of the time variable.

In step 610, the processing engine 112 may predict a service time point based on the second value(s) of the time variable. For example, if the processing engine 112 determines only one second value of the time variable, the processing engine 112 may predict a service time point as a time point corresponding to the determined second value of the time variable. As another example, if the processing engine 112 determines more than one second value of the time variable, the processing engine 112 may select one of the second values and predict a service time point as a time point corresponding to the selected second value of the time variable. As a further example, the processing engine 112 may determine more than one predicted service points. Each of the predicted service time points corresponds to one of the second values of the time variable.

In some embodiments, the processing engine 112 may determine the second value(s) of the time variable based on a set of instructions stored in the ROM 230 or the RAM 240. For example, the processing engine 112 may determine the value of the time variable according to python programming language.

For example, the processing engine 112 may define a struct to express each of the plurality of sections illustrated below:

struct section{float min,float mid,float max}

where float min refers to a start point of the section, float mid refers to a middle point of the section, and float max refers to an end point of the section. For example,

$$min = {a}_{i} , max = {a}_{i + 1} , mid = \frac{{a}_{i} + {a}_{i + 1}}{2}$$

The processing engine 112 may select a specific struct which corresponds to a specific section, and suppose that the value of the time variable is within the specific struct, according to specific struct, the processing engine 112 may modify formula (9) as below:

L(Xₛ)′=a·Xₛ+b (17)

Further, the processing engine 112 may determine a fourth value of the time variable which makes the first-order derivative of the quadratic sum of the plurality of time differences equal to 0 as below:

$${X}_{s} = - \frac{b}{a} \qquad ( 18 )$$

The processing engine 112 may further determine whether the fourth value of the time variable is within the specific struct, if so, the processing engine 112 may store the fourth value; if not, the processing engine 112 may select another struct and repeat the above process until all the plurality of structs are selected.

It should be noted that the processing engine 112 may determine the value of the time variable according to other programming languages, for example, C language, C++ language, Pascal language, JAVA language, SQL language, or the like, or a combination thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
a bus;
one or more storage media electronically connected to the bus, including a set of instructions for predicting a service time point of a passenger to use a transportation service; and
logic circuits electronically connected to the at least one storage medium via the bus, wherein during operation, the logic circuits load the set of instructions and:
obtain electronic signals from the bus, the electronic signals encoding a set of historical service time points of a passenger to use a transportation service through at least one online transportation service providing platform;
determine distribution information associated with the historical service time points;
predict a service time point based on the distribution information; and
send out electronic signals encoding information associated with the transportation service to the passenger within a predetermined time period prior to the predicted service time point.

2. The system of claim 1, wherein to predict the service time point based on the distribution information, the logic circuits further:
determine a plurality of first vectors based on the set of historical service time points, wherein each first vector is associated with one historical service time point from the set of historical service time points;
determine a second vector based on the plurality of first vectors; and
predict the service time point based on the second vector.

3. The system of claim 2, wherein the second vector is determined based on a sum of the plurality of first vectors.

4. The system of claim 2, wherein each of the plurality of first vectors is a unit vector that projects a corresponding historical service time point to a unit circular dial.

5. The system of claim 4, wherein each of the plurality of first vectors is associated with a rectangular coordinate system including:
a positive horizontal coordinate, referring to zero o'clock;
a negative horizontal coordinate, referring to twelve o'clock;
a positive vertical coordinate, referring to six o'clock; and
a negative vertical coordinate, referring to eighteen o'clock.

6. The system of claim 5, wherein the plurality of first vectors corresponds to a plurality of first angles with respect to the positive horizontal coordinate.

7. The system of claim 6, wherein to predict the service time point based on the distribution information, the logic circuits further:
determine a second angle of the second vector with respect to the positive horizontal coordinate; and
predict the service time point based on the second angle.

8. The system of claim 1, wherein the predicted service time point is a time such that the set of historical service time points has a statistically minimum error distribution in view of the predicted service time point.

9. The system of claim 8, wherein the error distribution includes a set of time differences, each time difference is associated with a difference between the predicted service time point and a historical service time point of the set of historical service time points, and
to predict the service time point, the logic circuits further:
determine a discrete parameter associated with the set of time differences;
determine a time corresponding to a minimum value of the discrete parameter; and
determine the time as the predicted service time point.

10. The system of claim 9, wherein to determine the time corresponding to a minimum value of the discrete parameter, the logic circuits further:
determine a first-order derivative of the discrete parameter; and
determine the time corresponding to the minimum value of the discrete parameter based on the first-order derivative.

11. The system of claim 9, wherein the discrete parameter includes a quadratic sum of the set of time differences, a variance of the set of time differences, or a standard deviation of the set of time differences.

12. A method, comprising:
obtaining, by at least one electronic device, a set of historical service time points of a passenger to use a transportation service through at least one online transportation service providing platform;
determining, by the at least one electronic device, distribution information associated with the historical service time points;
predicting, by the at least one electronic device, a service time point based on the distribution information; and
pushing, by the at least one electronic device, information associated with the transportation service to the passenger within a predetermined time period prior to the predicted service time point.

13. The method of claim 12, wherein the predicting of the service time point based on the distribution information includes:
determining, by the at least one electronic device, a plurality of first vectors based on the set of historical service time points, wherein each first vector is associated with one historical service time point from the set of historical service time points;
determining, by the at least one electronic device, a second vector based on the plurality of first vectors; and
predicting, by the at least one electronic device, the service time point based on the second vector.

14. The method of claim 13, wherein the second vector is determined based on a sum of the plurality of first vectors.

15. The method of claim 13, wherein each of the plurality of first vectors is a unit vector that projects a corresponding historical service time point to a unit circular dial.

16. The method of claim 15, wherein each of the plurality of first vectors is associated with a rectangular coordinate system including:
a positive horizontal coordinate, referring to zero o'clock;
a negative horizontal coordinate, referring to twelve o'clock;
a positive vertical coordinate, referring to six o'clock; and
a negative vertical coordinate, referring to eighteen o'clock.

17. The method of claim 16, wherein the plurality of first vectors corresponds to a plurality of first angles with respect to the positive horizontal coordinate.

18. The method of claim 17, wherein the predicting of the service time point based on the distribution information includes:
determining, by the at least one electronic device, a second angle of the second vector with respect to the positive horizontal coordinate; and
predicting, by the at least one electronic device, the service time point based on the second angle.

19. The method of claim 12, wherein the predicted service time point is a time such that the set of historical service time points has a statistically minimum error distribution in view of the predicted service time point.

20. The method of claim 19, wherein the error distribution includes a set of time differences, each time difference is associated with a difference between the predicted service time point and a historical service time point of the set of historical service time points, and
the predicting of the service time point includes:
determining, by the at least one electronic device, a discrete parameter associated with the set of time differences;
determining, by the at least one electronic device, a time corresponding to a minimum value of the discrete parameter; and
determining, by the at least one electronic device, the time as the predicted service time point.

21-22. (canceled)
